(19) United States
(12) Patent Application Publication
(10) Pub. No.: US 2007/0197258 A1
(43) Pub. Date: Aug. 23, 2007

(54) Signal transmission apparatus

(75) Inventors: Katsuya Oda, Kanagawa (JP); Hitomaro Tohgoh, Kanagawa (JP); Yoshiyasu Sato, Kanagawa (JP); Hiroaki Asano, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd, Kadoma-shi, (JP)

(21) Appl. No.: 10/592,329

(22) PCT Filed: Jun. 2, 2005
(86) PCT No.: PCT/JP05/10160

§ 371 Date: Sep. 11, 2006

(30) Foreign Application Priority Data
Jul. 9, 2004 (JP) 2005-202911

(51) Int. Cl. H04Q 7/20; H04M 1/00; H04B 1/38

(52) U.S. Cl. 455/554.2; 455/561; 455/426.2

(57) ABSTRACT

Up and down signal levels in a wireless base station and a forward base station can be automatically adjusted into predetermined levels respectively with a simple configuration. In an interface portion 12, a pilot signal P of a predetermined level is generated by a pilot signal generator 120, and multiplexed with a down transmission signal 111 from a wireless base station 11 by a multiplexer 121. The multiplexed signal is amplified with a constant gain by a down signal amplifier 122, then converted into a down optical signal by an electro-optic converter 123, wavelength-multiplexed by an optical multi/demultiplexer 124, sent out to an optical fiber 15, and transmitted to a forward base station 13. In the forward base station 13, the down optical signal wavelength-demultiplexed by an optical multi/demultiplexer 124 is converted into a down electric signal by an opto-electric converter 125, and the pilot signal P is demultiplexed by a demultiplexer 133. A gain control unit 130 detects an absolute level of the pilot signal P, and outputs a gain control signal G1 to set the level value at a predetermined rated value. A down signal gain variable amplifier 134 and an up signal gain variable amplifier 136 amplify the down transmission signal and the up reception signal respectively with a gain controlled by the gain control signal G1.

### TECHNICAL FIELD

The present invention relates to a signal transmission apparatus for transmitting signals between a wireless base station and a forward base station connected to this wireless base station through a wire transmission line in a mobile communication system.

### BACKGROUND ART

In a mobile communication system, a service area is divided into call zones, and a wireless base station is installed in each call zone. Each subscriber's wireless terminal (mobile communication terminal) such as each cellular phone or the like makes communication with this wireless base station by wireless. The wireless base station does not have only a radio transmitter-receiver but has a configuration in which functions such as processing in a baseband, interface with an exchange network, processing for time division or space division, call switching, etc. are aggregated. It is desired to make each call zone as narrow as possible from the point of view of power saving of each mobile communication terminal or effective use of radio frequency resources. However, when the call zone is narrowed, the number of wireless base stations increases so that the construction cost of the wireless base stations or the labor of maintenance increases.

In recent years, a mobile communication system using a micro-cell transmission system has been put into practice. In the micro-cell transmission system, a call zone of each wireless base station is divided into a plurality of micro-cells, and a forward base station with an antenna is installed in each micro-cell. Each mobile communication terminal makes wireless communication with this forward base station. The forward base station in the micro-cell transmission system is connected to the wireless base station through a wire transmission line such as an optical fiber, a coaxial cable or the like, while the forward base station performs wireless transmission/reception with mobile communication terminals in the micro-cell covered by the forward base station itself. Such a forward base station has a simple configuration so that the forward base station can be manufactured at a comparatively low price. In addition, there is an advantage that the forward base station can be installed anywhere and can be maintained without a lot of labor. Accordingly, when such a micro-cell transmission system is used, power saving of each mobile communication terminal or effective use of radio frequency resources can be attained without increasing the total system cost.

Recently, it is also attempted to install a plurality of antenna extension stations each covering a smaller area than the micro-cell on one and the same floor to support radio dead zones such as tall buildings, underground shopping areas, etc. where wireless communication cannot be established.

In the mobile communication system using the micro-cell transmission system, the transmission power level of a radio wave radiated from an antenna of each of the forward base stations (including the antenna extension stations, which can be also applied to similar cases below) to each mobile communication terminal and the up reception signal level with which the radio wave transmitted from the mobile communication terminal and received by the antenna of the forward base station is transmitted to a corresponding wireless base station have to be adjusted to fall into dynamic ranges of the mobile communication terminal and the wireless base station respectively. A manual level adjustment function is attached to a background-art forward base station. Those levels are adjusted to optimal levels by a construction site personnel or a maintenance personnel at the time of construction or at the time of maintenance. However, when a wire transmission line such as an optical fiber is exchanged or the forward base station is moved or added so that the length of the transmission line or the number of branches changes, the transmission power level and the up reception signal level have to be adjusted again, and much labor is required therefor.

As an example of a solution to this, there has been proposed an optical micro-cell transmission system having a configuration in which a wireless base station and a forward base station are connected through an optical fiber, and the levels of a down transmission signal and an up reception signal transmitted through the optical fiber are adjusted automatically (for example, see Patent Document 1).

FIG. 6 is a block diagram showing an example of the configuration of a signal transmission apparatus of an optical micro-cell transmission system in the background art. An interface portion 62 is connected to a wireless base station 61, and the interface portion 62 and a forward base station 63 are connected through up and down optical fibers 65 and 66. A pilot signal generator 630 is provided in the interface portion 62 so as to generate a down pilot signal modulated by a modulator 629 in accordance with a control signal from a control unit 628. The generated down pilot signal is multiplexed with a down transmission signal 67 by a multiplexer 621 and transmitted to the forward base station 63. In the forward base station 63, the down pilot signal is separated by a demultiplexer 633, and the level of the down pilot signal is detected by a demodulator 638. A control unit 639 controls the gain of a down signal gain variable amplifier 632 in accordance with the level of the down pilot signal. Thus, the transmission power level of the radio wave radiated from an antenna 64 can be kept constant even if there is a characteristic fluctuation due to a temperature change of the down signal gain variable amplifier 632.

On the other hand, a pilot signal generator 641 for generating an up pilot signal is provided in the forward base station 63. The generated up pilot signal and the reception signal received by the antenna 64 are multiplexed by a multiplexer 635 and transmitted to the interface portion 62. In the interface portion 62, the up pilot signal is separated by a demultiplexer 626, and the level of the up pilot signal is detected by a demodulator 627. A control unit 628 controls the gain of an up signal gain variable amplifier 625 in accordance with the detected level of the up pilot signal. Thus, the level of a reception signal 68 put into the wireless base station 61 can be kept constant even if there is a characteristic fluctuation due to a temperature change of the up signal gain variable amplifier 625.

When there arises an abnormality in any portion in the forward base station 63, the control unit 639 collects information about the abnormality and generates a status signal. This status signal is sent to a modulator 640, and the up pilot signal generated in the pilot signal generator 641 is modulated with the status signal. The modulated pilot signal is superposed on an up reception signal by the multiplexer 635, transmitted to the interface portion 62, demodulated by the demodulator 627, and sent as demodulated data to the control unit 628. The control unit 628 analyzes the demodulated data, detects the abnormality of the forward base station 63 and sends an abnormality information signal 69 to the wireless base station 61 so as to inform the wireless base station 61 of the abnormality.

In such an optical micro-cell transmission system, in the interface portion and the forward base station, pilot signals are multiplexed with a down transmission signal and an up reception signal respectively and transmitted mutually. The pilots signals are separated and the levels thereof are detected to control the corresponding gain variable amplifiers for amplifying the down transmission signal and the up reception signal. Thus, the levels of the down transmission signal and the up reception signal can be kept constant even if there are great temperature fluctuations in the characteristics of the amplifiers. It is therefore possible to allow fluctuations in the characteristics of the amplifiers due to temperature or the like, so that cheap amplifiers can be used. In addition, the control is carried out bypassing a plurality of amplifiers including any optical fiber section, any opto-electric converter and any electro-optic converter. It is therefore possible to easily deal with a change of the distance of the optical fiber section. Thus, it is possible to keep a constant transmission power and a constant reception gain. Further, since the pilot signals are modulated and transmitted, a forward base station located at a long distance from a wireless base station can be controlled, and abnormality in this forward base station can be detected.

In the aforementioned background-art optical micro-cell transmission system, however, a pilot signal generator, a multiplexer, a demultiplexer, a modulator and a demodulator are required for each system of a down transmission signal and an up reception signal in order to adjust the level of the up reception signal put into the wireless base station and the transmission power level of a radio wave radiated from an antenna of the forward base station so that those levels are constant. In addition, the system configuration becomes complicated because a function of detecting abnormality of the forward base station is also provided.

When a forward base station is placed at a comparatively short distance or when a plurality of antenna extension stations each covering an area smaller than a micro-cell are installed on one and the same floor in order to reduce radio dead zones such as tall buildings, underground shopping areas, etc., a coaxial cable, a cheap twisted pair cable or the like is used in a comparatively short transmission line whose transmission distance is not longer than 100 m. On the other hand, in the aforementioned background-art optical micro-cell transmission system, a broad band is required for transmitted up and down signals multiplexed with pilot signals respectively. Thus, the transmission line is limited to an optical fiber. It is therefore difficult to apply the optical micro-cell transmission system to a configuration where a transmission line of a coaxial cable or the like having a limited transmission band is used.
Patent Document 1: JP-A-8-149552

### DISCLOSURE OF THE INVENTION

### Problem that the Invention is to Solve

The present invention is developed in consideration of the aforementioned situation. An object of the invention is to provide a signal transmission apparatus in which the levels of up and down signals in a wireless base station and a forward base station can be automatically adjusted to predetermined levels respectively with a simple configuration.

### Means for Solving the Problem

A signal transmission apparatus according to the present invention is a signal transmission apparatus for bidirectionally transmitting signals between a wireless base station and a forward base station in a mobile communication system, the forward base station being connected to the wireless base station through a wire transmission line and making wireless communication with a communication terminal, wherein: an interface portion is provided in an input/output portion of the wireless base station; the interface portion includes a pilot signal generation portion for generating a pilot signal, and a multiplexer for multiplexing the pilot signal with a down transmission signal to be transmitted to the forward base station, the down transmission signal output from the multiplexer being transmitted to the forward base station through the wire transmission line; and the forward base station includes a demultiplexer for demultiplexing the pilot signal from the down transmission signal transmitted from the wireless base station, a down signal gain variable amplification portion for amplifying the down transmission signal, an up signal gain variable amplification portion for amplifying an up reception signal received from the communication terminal, and a gain control portion for generating a gain control signal in accordance with a level of the pilot signal and supplying the gain control signal to the down signal gain variable amplification portion and the up signal gain variable amplification portion so as to control output levels of the down transmission signal and the up reception signal.

In this manner, a pilot signal multiplexed with the down transmission signal in the interface portion is transmitted to the forward base station. In the forward base station, a gain control signal is generated in accordance with the level of the pilot signal so as to control the gain of the down signal gain variable amplification portion. Thus, the transmission power level of the down transmission signal sent out from the forward base station can be adjusted to a predetermined level, for example, to fall into a dynamic range of a communication terminal. In addition, the gain of the up signal gain variable amplification portion is controlled in accordance with the level of the pilot signal. Thus, the level of the up reception signal input to the wireless base station can be also adjusted to a predetermined level. In such a manner, transmission loss information about the transmission line obtained from the pilot signal is shared between the up transmission system and the down transmission system. Thus, the number of parts can be reduced, and the signal levels can be automatically adjusted with a simple configuration. Further, since the pilot signal is multiplexed only with the down transmission signal, a broad band is not required in the transmission line. Thus, not only an optical fiber cable but also a metallic cable such as a coaxial cable, a twisted pair cable or the like can be used.

According to another mode of the present invention, the aforementioned signal transmission apparatus is designed so that the wire transmission line is constituted by an optical fiber cable so as to transmit a down optical signal and an up optical signal between the interface portion and the forward base station; the interface portion further includes a first electro-optic converter for converting the down transmission signal into the down optical signal, and a first opto-electric converter for converting the up optical signal transmitted from the forward base station, into the up reception signal; and the forward base station further includes a second opto-electric converter for converting the down optical signal transmitted from the interface portion, into the down transmission signal, and a second electro-optic converter for converting the up reception signal amplified by the up signal gain variable amplifier, into the up optical signal.

In this manner, when signals are transmitted between the interface portion and the forward base station through the wire transmission line of the optical fiber cable, the transmission power level of the down transmission signal sent out from the forward base station and the level of the up reception signal input to the wireless base station can be automatically adjusted with a simple configuration.

According to another mode of the present invention, the aforementioned signal transmission apparatus is designed so that the wire transmission line is constituted by a single optical fiber; the interface portion further includes a first optical multi/demultiplexer connected to the optical fiber and for performing wavelength division multiplexing transmission of the down optical signal and the up optical signal with the forward base station; and the forward base station further includes a second optical multi/demultiplexer connected to the optical fiber and for performing wavelength division multiplexing transmission of the up optical signal and the down optical signal with the interface portion.

In this manner, when signals are transmitted between the interface portion and the forward base station through the wire transmission line of the optical fiber cable using a single optical fiber, the transmission power level of the down transmission signal sent out from the forward base station and the level of the up reception signal input to the wireless base station can be automatically adjusted with a simple configuration.

A signal transmission apparatus according to the present invention is a signal transmission apparatus for bidirectionally transmitting signals between a wireless base station and a forward base station in a mobile communication system, the forward base station being connected to the wireless base station through a wire transmission line and making wireless communication with a communication terminal, wherein: an interface portion is provided in an input/output portion of the wireless base station, and the wire transmission line is made of a metallic cable; the interface portion includes a DC power generation portion for generating DC power, and a superposition circuit for superposing the DC power on a down transmission signal to be transmitted to the forward base station, the down transmission signal output from the superposition circuit being transmitted to the forward base station through the wire transmission line; and the forward base station includes a separation circuit for separating the DC power from the down transmission signal transmitted from the wireless base station, a down signal gain variable amplification portion for amplifying the down transmission signal, an up signal gain variable amplification portion for amplifying an up reception signal received from the communication terminal, and a gain control portion for generating a gain control signal in accordance with a value of the DC power and supplying the gain control signal to the down signal gain variable amplification portion and the up signal gain variable amplification portion so as to control output levels of the down transmission signal and the up reception signal.

In this manner, in the interface portion, DC power is superposed on the down transmission signal and transmitted to the forward base station. In the forward base station, a gain control signal is generated in accordance with the value of the DC power so as to control the gain of the down signal gain variable amplification portion. Thus, the transmission power level of the down transmission signal sent out from the forward base station can be adjusted to a predetermined level. In addition, the gain of the up signal gain variable amplification portion is controlled in accordance with the value of the DC power. Thus, the level of the up reception signal input to the wireless base station can be also adjusted to a predetermined level. In such a manner, transmission loss information about the transmission line obtained from the DC power serving as a pilot signal is shared between the up transmission system and the down transmission system. Thus, the number of parts can be reduced, and the signal levels can be automatically adjusted with a simple configuration. Further, since the DC power is superposed only on the down transmission signal, a broad band is not required in the transmission line. Thus, this configuration can be applied to a transmission line of a metallic cable such as a coaxial cable, a twisted pair cable or the like. Further, since the DC power is superposed and transmitted to detect the transmission loss information, phantom power feeding to the forward base station can be attained. Thus, the forward base station may be designed to have no power supply circuit. It is therefore possible to simplify the apparatus configuration.

A signal transmission apparatus according to the present invention is a signal transmission apparatus for bidirectionally transmitting signals between a wireless base station and a forward base station in a mobile communication system, the forward base station being connected to the wireless base station through a wire transmission line and making wireless communication with a communication terminal, wherein: an interface portion is provided in an input/output portion of the wireless base station, and the wire transmission line is made of a metallic cable including a down transmission line for transmitting a down transmission signal from the wireless base station to the forward base station and an up transmission line for transmitting an up reception signal from the forward base station to the wireless base station; the interface portion includes a pilot signal generation portion for generating a pilot signal, and a multiplexer for multiplexing the pilot signal on the up transmission line; and the forward base station includes a demultiplexer for demultiplexing the pilot signal input through the up transmission line, a down signal gain variable amplification portion for amplifying the down transmission signal, an up signal gain variable amplification portion for amplifying an up reception signal received from the communication terminal, and a gain control portion for generating a gain control signal in accordance with a level of the pilot signal and supplying the gain control signal to the down signal gain variable amplification portion and the up signal gain variable amplification portion so as to control output levels of the down transmission signal and the up reception signal.

In this manner, a pilot signal multiplexed on the up transmission line in the interface portion is transmitted to the forward base station. In the forward base station, a gain control signal is generated in accordance with the level of the pilot signal so as to control the gain of the down signal gain variable amplification portion. Thus, the transmission power level of the down transmission signal sent out from the forward base station can be adjusted to a predetermined level. In addition, the gain of the up signal gain variable amplification portion is controlled in accordance with the level of the pilot signal. Thus, the level of the up reception signal input to the wireless base station can be also adjusted to a predetermined level. When the pilot signal is multiplexed on the up transmission line in such a manner, the transmission direction of the up reception signal to be transmitted differs from that of the pilot signal. Accordingly, even when the frequency band of the pilot signal overlaps that of the up reception signal, there is no deterioration in transmission quality, and it is possible to suppress increase of the transmission band caused by multiplexing of the pilot signal. Accordingly, this configuration is useful to a system using a twisted pair cable having a limit in the band of a transmission line or a coaxial cable having a frequency characteristic as its transmission characteristic. Thus, the cost of the system as a whole can be reduced.

According to another mode of the present invention, the aforementioned signal transmission apparatus is designed so that the interface portion further includes a first current detection portion for detecting a value of a current flowing in the first opto-electric converter, and a first alarm output portion for comparing the detected current value with a predetermined value and outputting an alarm signal when the detected current value is lower than the predetermined value; and the forward base station further includes a second current detection portion for detecting a value of a current flowing in the second opto-electric converter, and a second alarm output portion for comparing the detected current value with a predetermined value and outputting an alarm signal when the detected current value is lower than the predetermined value.

In this manner, the value of a current flowing in the opto-electric converter in each of the interface portion and the forward base station is detected. When this current value is lower than a predetermined value, an alarm signal is output. Thus, an abnormality of the system, such as circuit disconnection of the transmission line, bending in the circuit, or the like, can be detected rapidly by the alarm signal.

According to another mode of the present invention, the aforementioned signal transmission apparatus is designed so that the forward base station further includes a first pilot signal detection portion for detecting the demultiplexed pilot signal, a first alarm output portion for comparing a level of the detected pilot signal with a predetermined value and outputting an alarm signal when the level of the detected pilot signal is lower than the predetermined value, and a second multiplexer for multiplexing the demultiplexed pilot signal on the down transmission line; and the interface portion further includes a second demultiplexer for demultiplexing the pilot signal input through the down transmission line, a second pilot signal detection portion for detecting the demultiplexed pilot signal, and a second alarm output portion for comparing a level of the detected pilot signal with a predetermined value and outputting an alarm signal when the level of the detected pilot signal is lower than the predetermined value.

In such a manner, the level of the pilot signal in each of the interface portion and the forward base station is detected. When this level is lower than a predetermined value, an alarm signal is output. Thus, an abnormality of the system, such as circuit disconnection of the transmission line, bending in the circuit, or the like, can be detected rapidly by the alarm signal.

### Effect of the Invention

According to the present invention, it is possible to provide a signal transmission apparatus in which up and down signal levels in a wireless base station and a forward base station can be automatically adjusted to predetermined levels respectively with a simple configuration.

### BRIEF DESCRIPTION OF THE DRAWINGS

FIG. 1 A diagram showing the schematic configuration of a signal transmission apparatus according to a first embodiment of the present invention.

FIG. 2 A diagram showing the schematic configuration of a signal transmission apparatus according to a second embodiment of the present invention.

FIG. 3 A diagram showing the schematic configuration of a signal transmission apparatus according to a third embodiment of the present invention.

FIG. 4 A diagram showing the schematic configuration of a signal transmission apparatus according to a fourth embodiment of the present invention.

FIG. 5 A diagram showing the schematic configuration of a signal transmission apparatus according to a fifth embodiment of the present invention.

FIG. 6 A diagram showing the schematic configuration of a signal transmission apparatus in the background art.

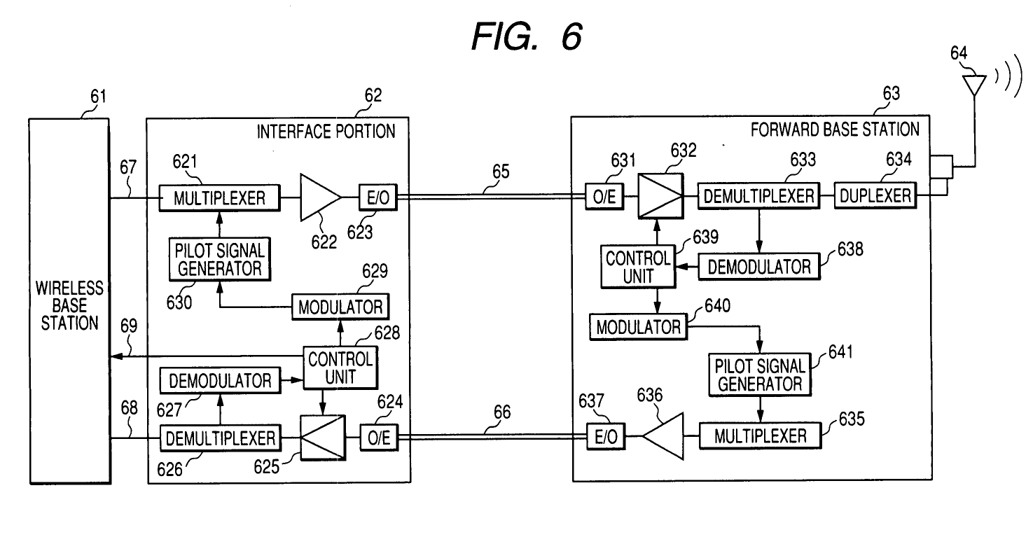

### DESCRIPTION OF REFERENCE NUMERALS

11 wireless base station
12, 22, 32, 42, 52 interface portion
13, 23, 43, 43, 53 forward base station
14 antenna
15 optical fiber
25 metallic cable
35 down transmission line
36 up transmission line
111 down transmission signal
112 up reception signal
120 pilot signal generator
121 multiplexer
123 electro-optic converter
124 optical multi/demultiplexer
125 opto-electric converter
130, 330, 530 gain control unit
133 demultiplexer
134 down signal gain variable amplifier
136 up signal gain variable amplifier
227 current detection circuit
228 alarm output circuit
327 directional multiplexer
338 direction demultiplexer
428 pilot signal detection circuit
520 DC power generating circuit
521 superposition circuit
524 electric multi/demultiplexer
533 separation circuit

### BEST MODE FOR CARRYING OUT THE INVENTION

Embodiments of the present invention exemplify configurations of a signal transmission apparatus provided in a mobile communication system using a micro-cell transmission system. In this micro-cell transmission system, a wireless base station installed in each call zone and a forward base station installed in each micro-cell of the call zone divided into a plurality of micro-cells are connected through a wire transmission line, and signal transmission is performed mutually between the wireless base station and the forward base station. The forward base station makes wireless communication with mobile communication terminals in the micro-cell so as to relay communication signals between the wireless base station and each mobile communication terminal. Constituent parts common to the following drawings are referenced correspondingly.

### FIRST EMBODIMENT

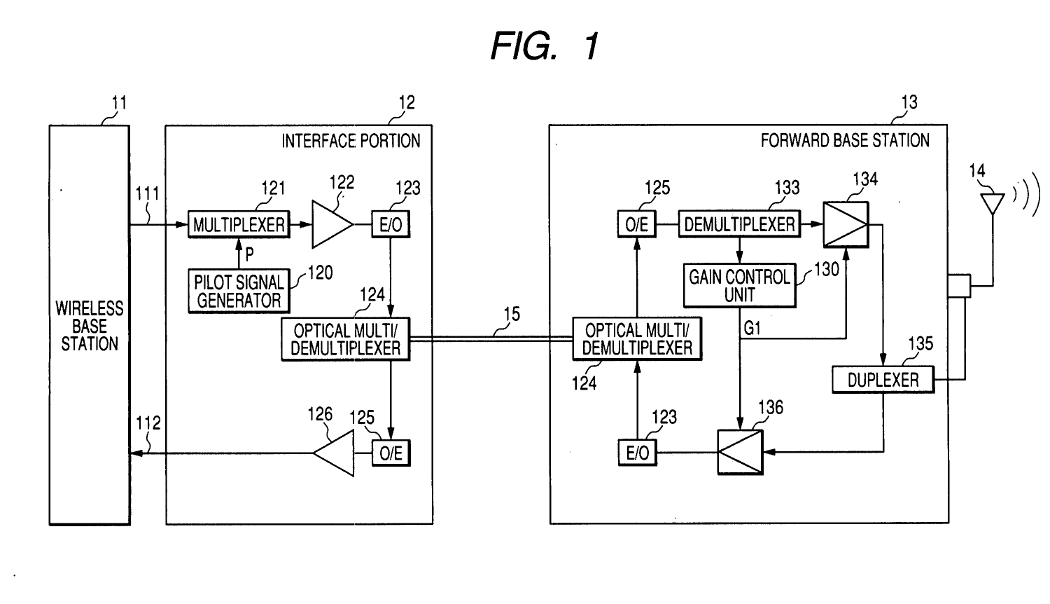

FIG. 1 is a diagram showing the schematic configuration of a signal transmission apparatus according to a first embodiment of the present invention. In the configuration, an interface portion 12 connected to a wireless base station 11, and a forward base station 13 making wireless communication with mobile communication terminals in a micro-cell covered by the forward base station 13 itself through an antenna 14, are connected through a single optical fiber 15. A plurality of interface portions 12 are typically connected to the wireless base station 11 so as to perform mutual signal transmission with forward base stations installed in a plurality of micro-cells respectively in a call zone assigned to the wireless base station 11 itself. However, the plurality of interface portions 12 are not shown in FIG. 1.

The interface portion 12 is designed to have a pilot signal generator 120 (equivalent to an example of a pilot signal generating portion) for generating a pilot signal P of a predetermined level, a multiplexer 121 for multiplexing the pilot signal P with a down transmission signal 111 from the wireless base station 11, a down signal amplifier 122 for amplifying a signal from the multiplexer 21 with a predetermined constant gain, an electro-optic converter (E/O) 123 for converting an electric signal output from the down signal amplifier 122 into an optical signal, an optical multi/demultiplexer 124 for wavelength-multiplexing and outputting the optical signal from the electro-optic converter 123 onto the optical fiber 15 and wavelength-demultiplexing an optical signal from the optical fiber 15, an opto-electric converter (O/E) 125 for converting the demultiplexed optical signal into an electric signal, and an up signal amplifier 126 for amplifying the electric signal from the opto-electric converter 125 with a constant gain.

On the other hand, the forward base station 13 is designed to have an optical multi/demultiplexer 124 for wavelength-demultiplexing an optical signal from the optical fiber 15 as an input and for wavelength-multiplexing an optical signal from an electro-optic converter 123 as an output onto the optical fiber 15, an opto-electric converter (O/E) 125 for converting the demultiplexed optical signal into an electric signal, a demultiplexer 133 for demultiplexing the down transmission signal 111 and the pilot signal P wavelength-multiplexed by the multiplexer 121 of the interface portion 12, a gain control unit 130 (equivalent to an example of a gain control portion) for detecting the absolute level of the demultiplexed pilot signal P and outputting a gain control signal G1 to set the detected level at a predetermined rated value, a down signal gain variable amplifier 134 (equivalent to an example of a down signal gain variable amplification portion) for amplifying the down transmission signal 111 with a gain controlled by the gain control signal G1, a duplexer 135 for sharing the antenna 14 between a transmission system and a reception system, an up signal gain variable amplifier 136 (equivalent to an example of an up signal gain variable amplification portion) for amplifying an up reception signal from a mobile communication terminal received by the antenna 14, with a gain controlled by the gain control signal G1, and an electro-optic converter (E/O) 123 for converting the amplified up reception signal into an optical signal.

Next, description will be made about the operation of the signal transmission apparatus according to the first embodiment.

A down pilot signal P is multiplexed with a down transmission signal 111 input from the wireless base station 11 to the interface portion 12 by the multiplexer 121, amplified with a predetermined constant gain by the down signal amplifier 122, then converted into an optical signal by the electro-optic converter 123, wavelength-multiplexed by the optical multi/demultiplexer 124, and sent out to the optical fiber 15.

In the forward base station 13, the optical signal sent from the interface portion 12 through the optical fiber 15 is wavelength-demultiplexed and received by the optical multi/demultiplexer 124, converted into an electric signal by the opto-electric converter 125, and input to the demultiplexer 133. In the demultiplexer 133, the down transmission signal 111 and the pilot signal P are demultiplexed from the input signal, and input to the down signal amplifier gain variable amplifier 134 and the gain control unit 130 respectively. The absolute level of the pilot signal P is detected by the gain control unit 130, and a gain control signal G1 to set the detected level at a predetermined rated value is output. On the other hand, the demultiplexed down transmission signal 111 is input to the down signal amplifier gain variable amplifier 134, and amplified with a gain controlled by the gain control signal G1. As a result, a down transmission signal always having a constant level is output from the down signal amplifier gain variable amplifier 134. The down transmission signal is sent to the antenna 14 through the duplexer 135, and radiated as a radio wave with a constant transmission power to the area of the micro-cell covered by the forward base station 13 itself.

On the other hand, an up reception signal radiated from a mobile communication terminal and received through the antenna 14 is input to the up signal gain variable amplifier 136 through the duplexer 135, and amplified with a gain controlled by the gain control signal G1. Consequently, an up reception signal always having a constant level in expectation of a transmission loss of the optical fiber 15 and so on can be obtained from the signal gain variable amplifier 136. The up reception signal amplified thus is converted into an optical signal by the electro-optic converter 123, wavelength-multiplexed by the optical multi/demultiplexer 124, and sent out to the optical fiber 15.

In the interface portion 12, the optical signal sent from the forward base station 13 through the optical fiber 15 is wavelength-demultiplexed and received by the optical multi/demultiplexer 124, converted into an electric signal by the opto-electric converter 125, and amplified with a predetermined constant gain by the up signal amplifier 126. Thus, an up reception signal 112 always having a constant level is output from the up signal amplifier 126, and input to the wireless base station 11.

In the aforementioned manner, according to the first embodiment, a pilot signal P of a predetermined level is generated by the pilot signal generator 120 of the interface portion 12, multiplexed with a down transmission signal 111 by the multiplexer 121, and transmitted to the forward base station 13 through the optical fiber 15. In the forward base station 13, the pilot signal P is demultiplexed by the demultiplexer 133, and the absolute level thereof is detected by the gain control unit 130 so as to output a gain control signal G1 to set the detected level at a predetermined rated value. The gains of the down signal gain variable amplifier 134 and the up signal gain variable amplifier 136 are controlled by the gain control signal G1. Thus, the transmission power level of a radio wave radiated from the antenna 14 and the level of the up reception signal 112 input to the wireless base station 11 can be always kept constant.

Since the gains of the down signal gain variable amplifier 134 and the up signal gain variable amplifier 136 are controlled only by the pilot signal generated by the interface portion 12, the configuration can be made simple. In addition, the gain of the up signal gain variable amplifier 136 can be adjusted regardless of whether there is an up reception signal or not. Even if a signal is sent from a mobile communication terminal at a burst, the level of an up reception signal input to the wireless base station 11 can be kept constant.

### SECOND EMBODIMENT

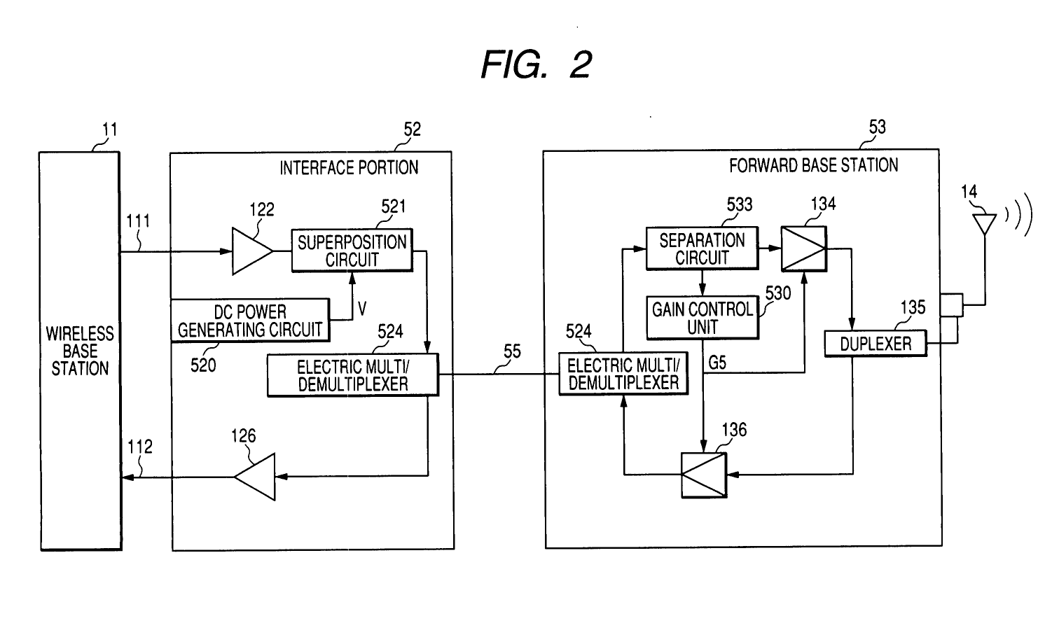

FIG. 2 is a diagram showing the schematic configuration of a signal transmission apparatus according to a second embodiment of the present invention. In the configuration, an interface portion 52 connected to a wireless base station 11 and a forward base station 53 are connected through a single-wire metallic cable 55 such as a coaxial cable or the like.

The interface portion 52 is designed to have a down signal amplifier 122 for amplifying a down transmission signal 111 input from the wireless base station 11 with a predetermined constant gain, a DC power generating circuit 520 (equivalent to an example of a DC power generation portion) for generating DC power V of a predetermined level, a superposition circuit 521 for superposing the DC power V on the amplified down transmission signal, an electric multi/demultiplexer 524 for frequency-multi/demultiplexing a down transmission signal and an up reception signal transmitted through the metallic cable 55, and an up signal amplifier 126 for amplifying the demultiplexed input up reception signal with a constant gain.

On the other hand, the forward base station 53 is designed to have an electric multi/demultiplexer 524, a separation circuit 533 for separating the DC power V and the up transmission signal, a gain control unit 530 (equivalent to an example of a gain control portion) for detecting the absolute level of the separated DC power V and outputting a gain control signal G5 to set the detected level at a predetermined rated value, a down signal gain variable amplifier 134 for amplifying the down transmission signal with a gain controlled by the gain control signal G5, a duplexer 135 for sharing the antenna 14 between a transmission system and a reception system, and an up signal gain variable amplifier 136 for amplifying an up reception signal from a mobile communication terminal received by the antenna 14, with a gain controlled by the gain control signal G5.

Next, description will be made about the operation of the signal transmission apparatus according to the second embodiment.

A down transmission signal 111 input from the wireless base station 11 to the interface portion 52 is amplified with a predetermined constant gain by the down signal amplifier 122, superimposed with the DC power V by the superposition circuit 521, frequency-multiplexed by the electric multi/demultiplexer 524, and sent out to the metallic cable 55.

In the forward base station 53, the electric signal sent from the interface portion 52 through the metallic cable 55 is wavelength-demultiplexed and received by the electric multi/demultiplexer 524, and separated into the down transmission signal and the DC power V by the separation circuit 533. The absolute level of the separated DC power V is detected by the gain control unit 530, and a gain control signal G5 to set the detected level at a predetermined rated value is output. On the other hand, the down transmission signal separated by the separation circuit 533 is input to the down signal amplifier gain variable amplifier 134, and amplified with a gain controlled by the gain control signal G5. As a result, a down transmission signal always having a constant level is output from the down signal amplifier gain variable amplifier 134. The down transmission signal is sent to the antenna 14 through the duplexer 135, and radiated as a radio wave with a constant transmission power to the area of the micro-cell covered by the forward base station 53 itself.

On the other hand, an up reception signal radiated from a mobile communication terminal and received through the antenna 14 is input to the up signal gain variable amplifier 136 through the duplexer 135, and amplified with a gain controlled by the gain control signal G5. Consequently, an up reception signal always having a constant level in expectation of a transmission loss of the metallic cable 55 and so on can be obtained from the signal gain variable amplifier 136. The up reception signal amplified thus is frequency-multiplexed by the electric multi/demultiplexer 524, and sent out to the metallic cable 55.

In the interface portion 52, the electric signal sent from the forward base station 53 through the metallic cable 55 is frequency-demultiplexed and received by the electric multi/demultiplexer 524, and amplified with a predetermined constant gain by the up signal amplifier 126. Thus, an up reception signal 112 always having a constant level is output from the up signal amplifier 126, and input to the wireless base station 11.

In the aforementioned manner, according to the second embodiment, DC power V of a predetermined level is generated by the DC power generating circuit 520 of the interface portion 52, superposed on a down transmission signal 111 by the superposition circuit 521, and transmitted to the forward base station 53 through the metallic cable 55. In the forward base station 53, the DC power V is separated by the separation circuit 533, and the absolute level thereof is detected by the gain control unit 530 so as to output a gain control signal G5 to set the detected level at a predetermined rated value. The gains of the down signal gain variable amplifier 134 and the up signal gain variable amplifier 136 are controlled by the gain control signal G5.

Thus, effect similar to that of the first embodiment can be obtained. In addition, phantom powering from the interface portion 52 to the forward base station 53 can be performed. It is therefore unnecessary to provide any power supply unit in the forward base station 53.

### THIRD EMBODIMENT

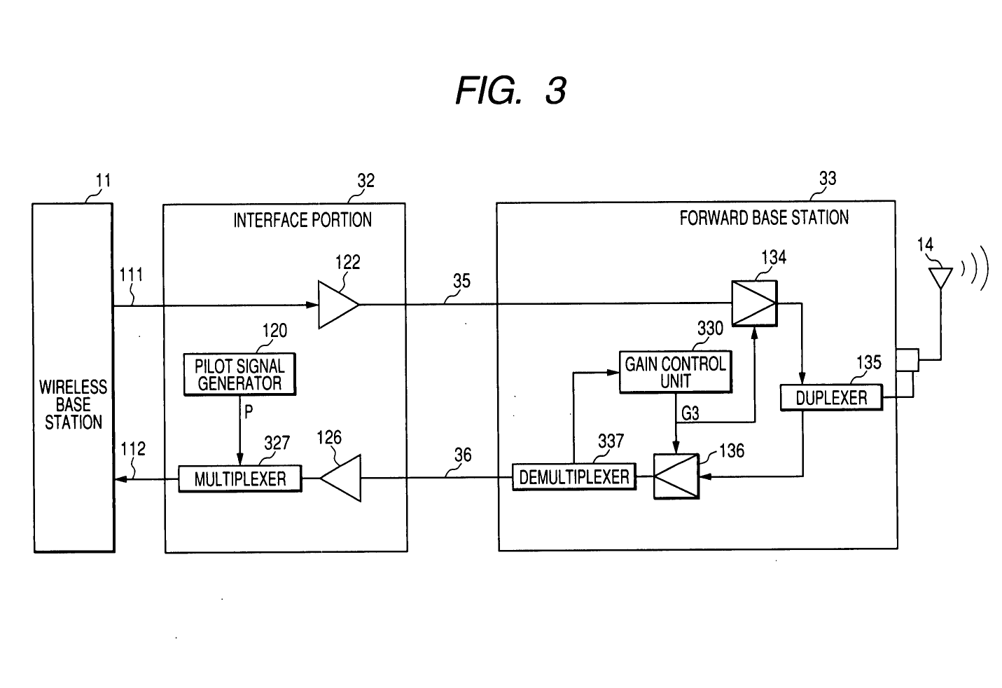

FIG. 3 is a diagram showing the schematic configuration of a signal transmission apparatus according to a third embodiment of the present invention. In the configuration, an interface portion 32 connected to a wireless base station 11 and a forward base station 33 are connected through a two-wire metallic cable such as a twisted pair cable or the like constituted by a down signal transmission line 35 and an up signal transmission line 36.

The interface portion 32 is designed to have a down signal amplifier 122 for amplifying a down transmission signal 111 input from the wireless base station 11 with a predetermined constant gain, an up signal amplifier 126 for amplifying an up reception signal transmitted from the forward base station 33 through the up signal transmission line 36 with a constant gain, a pilot signal generator 120 (equivalent to an example of a pilot signal generation portion) for generating a pilot signal P of a predetermined level, and a multiplexer 327 for multiplexing the pilot signal P on the up signal transmission line 36. This multiplexer 327 is a directional device such as a directional coupler or a circulator.

On the other hand, the forward base station 33 is designed to have a directional demultiplexer 337 for demultiplexing the pilot signal P from the up signal transmission line 36, a gain control unit 330 (equivalent to an example of a gain control portion) for detecting the absolute level of the demultiplexed pilot signal P and outputting a gain control signal G3 to set the detected level at a predetermined rated value, a down signal gain variable amplifier 134 for amplifying the down transmission signal with a gain controlled by the gain control signal G3, a duplexer 135 for sharing the antenna 14 between a transmission system and a reception system, and an up signal gain variable amplifier 136 for amplifying an up reception signal from a mobile communication terminal received by the antenna 14, with a gain controlled by the gain control signal G3.

Next, description will be made about the operation of the signal transmission apparatus according to the third embodiment.

A down transmission signal 111 input from the wireless base station 11 to the interface portion 32 is amplified with a predetermined constant gain by the down signal amplifier 122, and transmitted to the forward base station 33 through the down signal transmission line 35 of the metallic cable.

In the forward base station 33, first, the pilot signal P is demultiplexed from the up signal transmission line 36 by the demultiplexer 337. The absolute level of the demultiplexed pilot signal P is detected by the gain control unit 330, and a gain control signal G3 to set the detected level at a predetermined rated value is output. The down transmission signal transmitted from the interface portion 32 through the down signal transmission line 35 is sent to the down signal amplifier gain variable amplifier 134 and amplified with a gain controlled by the gain control signal G3. As a result, a down transmission signal always having a constant level is output from the down signal amplifier gain variable amplifier 134. The down transmission signal is sent to the antenna 14 through the duplexer 135, and radiated as a radio wave with a constant transmission power to the area of the micro-cell covered by the forward base station 33 itself.

On the other hand, an up reception signal radiated from a mobile communication terminal and received through the antenna 14 is input to the up signal gain variable amplifier 136 through the duplexer 135, and amplified with a gain controlled by the gain control signal G3. Consequently, an up reception signal always having a constant level in expectation of a transmission loss of the metallic cable and so on can be obtained from the signal gain variable amplifier 136. This up reception signal is sent out to the up signal transmission line 36 of the metallic cable through the demultiplexer 338, and transmitted to the interface portion 32.

In the interface portion 32, the electric signal transmitted from the forward base station 33 through the up signal transmission line 36 is received, and amplified with a predetermined constant gain by the up signal amplifier 126. Thus, an up reception signal 112 always having a constant level is output from the up signal amplifier 126, and input to the wireless base station 11.

In the aforementioned manner, according to the third embodiment, a pilot signal P of a predetermined level is generated by the pilot signal generator 120 of the interface portion 32, multiplexed on the system for transmitting an up reception signal by the multiplexer 327, and transmitted to the forward base station 33 through the up signal transmission line 36 of the metallic cable. In the forward base station 33, the pilot signal P is demultiplexed by the demultiplexer 337, and the absolute level thereof is detected by the gain control unit 330 so as to output a gain control signal G3 to set the detected level at a predetermined rated value. The gains of the down signal gain variable amplifier 134 and the up signal gain variable amplifier 136 are controlled by the output gain control signal G3.

Thus, effect similar to that of the first embodiment can be obtained. In addition, the pilot signal P is multiplexed on the up signal transmission line 36 of the metallic cable because a directional device such as a directional coupler or a circulator is used as each of the multiplexer 327 and the demultiplexer 337. Even when the frequency band of the pilot signal P overlaps that of the up reception signal, their different transmission directions prevent the transmission quality from deteriorating. It is therefore unnecessary to expand the transmission frequency band. Accordingly, this embodiment is useful to a transmission system using a twisted pair cable having a narrow transmission band or a coaxial cable having a frequency characteristic as a transmission characteristic.

### FOURTH EMBODIMENT

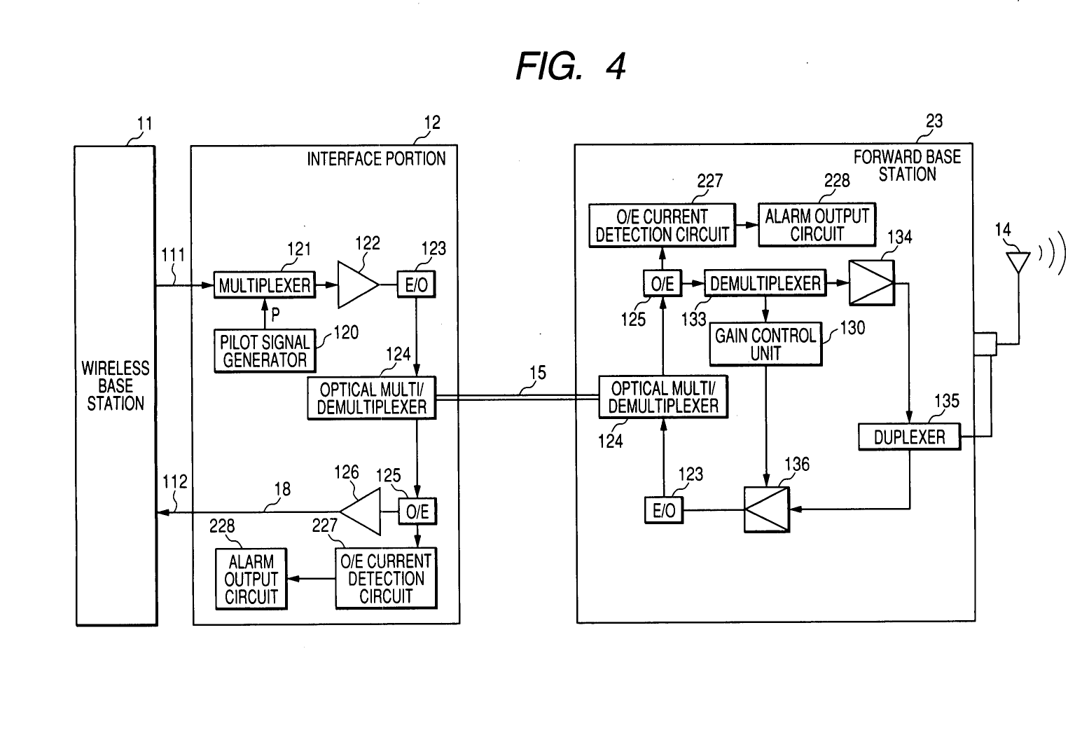

FIG. 4 is a diagram showing the schematic configuration of a signal transmission apparatus according to a fourth embodiment of the present invention. In the configuration, an interface portion 22 connected to a wireless base station 11 and a forward base station 23 are connected through a single optical fiber 15.

In addition to the configuration of the interface portion 12 according to the first embodiment shown in FIG. 1, the interface portion 22 is designed to have a current detection circuit 227 (equivalent to an example of a first current detection portion) for detecting a current value when an optical signal is converted into an electric signal in the opto-electric converter 125, and an alarm output circuit 228 (equivalent to an example of a first alarm output portion) for comparing the detected current value with a predetermined current value and outputting an alarm signal when the former is lower than the latter.

On the other hand, in addition to the configuration of the forward base station 13 according to the first embodiment shown in FIG. 1, the forward base station 23 is designed to have a current detection circuit 227 (equivalent to an example of a second current detection portion) for detecting a current value when an optical signal is converted into an electric signal in the opto-electric converter 125, and an alarm output circuit 228 (equivalent to an example of a second alarm output portion).

Next, description will be made about the operation of the signal transmission apparatus according to the fourth embodiment. Description about operation shared with the signal transmission apparatus according to the first embodiment shown in FIG. 1 will be omitted.

In the interface portion 22, an optical signal sent from the forward base station 23 through the optical fiber 15 is wavelength-demultiplexed and received by the optical multi/demultiplexer 124, and converted into an electric signal by the opto-electric converter 125. The current in this event is detected by the current detection circuit 227 and compared with a predetermined current value by the alarm output circuit 228. When the detected current value is lower than the predetermined current value, it is concluded that a failure such as circuit disconnection or bending occurs in the optical fiber 15, and an alarm signal is output.

On the other hand, in the forward base station 23, an optical signal sent from the interface portion 12 through the optical fiber 15 is wavelength-demultiplexed and received by the optical demultiplexer 124, and converted into an electric signal by the opto-electric converter 125. The current in this event is detected by the current detection circuit 227 and compared with a predetermined current value by the alarm output circuit 228. When the detected current value is lower than the predetermined current value, it is concluded that there is an abnormality in the transmission line, and an alarm signal is output.

As described above, in the fourth embodiment, in addition to the configuration and operation of the first embodiment, in each of the interface portion 22 and the forward base station 23, the current value obtained when an optical signal received through the optical fiber 15 is converted into an electric signal by the opto-electric converter circuit 125 is detected by the current detection circuit 227, and the detected current value is compared with a predetermined current value by the alarm output circuit 228. When the former is lower than the latter, it is concluded that there is an abnormality in the optical fiber 15, and an alarm signal is output. As a result, as soon as there occurs a failure such as circuit disconnection or bending in the optical fiber 15, the failure can be detected and an alarm can be given immediately. Thus, in addition to the effect of the first embodiment, the abnormality of the system can be sensed rapidly.

### FIFTH EMBODIMENT

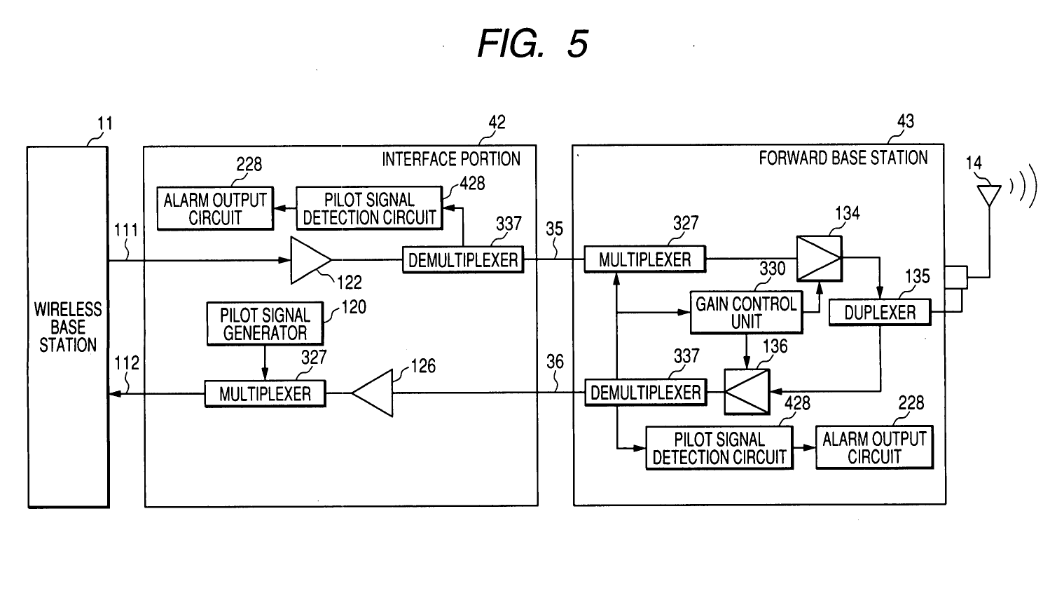

FIG. 5 is a diagram showing the schematic configuration of a signal transmission apparatus according to a fifth embodiment of the present invention. In the configuration, an interface portion 42 connected to a wireless base station 11 and a forward base station 43 are connected through a two-wire metallic cable such as a twisted pair cable or the like constituted by a down signal transmission line 35 and an up signal transmission line 36.

In addition to the configuration of the interface portion 32 according to the third embodiment shown in FIG. 3, the interface portion 42 is designed to have a directional demultiplexer 337 for demultiplexing a pilot signal P from the down signal transmission line 35 of the metallic cable, a pilot signal detection circuit 428 (equivalent to an example of a second pilot signal detection portion) for detecting the demultiplexed pilot signal P, and an alarm output circuit 228 (equivalent to an example of a second alarm output portion) for comparing the detected pilot signal P with a predetermined value and outputting an alarm signal when the former is lower than the latter.

On the other hand, in addition to the configuration of the forward base station 33 according to the third embodiment shown in FIG. 3, the forward base station 43 is designed to have a directional multiplexer 327 for receiving the pilot signal P demultiplexed by the demultiplexer 337 and multiplexing the pilot signal P on the line for transmitting the down transmission signal, a pilot signal detection circuit 428 (equivalent to an example of a first pilot signal detection portion) for detecting the demultiplexed pilot signal P, and an alarm output circuit 228 (equivalent to an example of a first alarm output portion) for comparing the detected pilot signal P with the predetermined value, and outputting an alarm signal when the former is lower than the latter.

Next, description will be made about the operation of the signal transmission apparatus according to the fifth embodiment. Description about operation shared with the signal transmission apparatus according to the third embodiment shown in FIG. 3 will be omitted.

In the interface portion 42, the pilot signal P transmitted from the forward base station 43 through the down signal transmission line 35 of the metallic cable is demultiplexed by the demultiplexer 337, and the absolute level thereof is detected by the pilot signal detection circuit 428. The detected level of the pilot signal P is compared with a predetermined level value by the alarm output circuit 228. When the detected level is lower than the predetermined value, it is concluded that there is an abnormality in the transmission line, and an alarm signal is output. Thus, it is possible to know that there has occurred a failure such as disconnection or the like in the down signal transmission line 35 of the metallic cable.

On the other hand, in the forward base station 43, the pilot signal P transmitted from the interface portion 42 through the up signal transmission line 36 of the metallic cable is demultiplexed by the demultiplexer 337, and the absolute level thereof is detected by the pilot signal detection circuit 428. The detected level of the pilot signal P is compared with a predetermined level value by the alarm output circuit 228. When the detected level is lower than the predetermined value, it is concluded that there is an abnormality in the transmission line, and an alarm signal is output. Thus, it is possible to know that there has occurred a failure such as disconnection or the like in the up signal transmission line 36 of the metallic cable.

In the aforementioned manner, according to the fifth embodiment, in addition to the configuration and operation of the third embodiment, in the interface portion 42 and the forward base station 43, the level of the pilot signal P transmitted through each of the down signal transmission line 35 and the up signal transmission line 36 of the metallic cable is detected by the pilot signal detection circuit 428, and the detected level is compared with a predetermined value by the alarm output circuit 228. When the former is lower than the latter, it is concluded that there is an abnormality in the transmission line, and an alarm signal is output. As a result, as soon as there occurs a failure such as disconnection or the like in the metallic cable, the failure can be detected and an alarm can be given immediately. Thus, in addition to the effect of the third embodiment, the abnormality of the system can be sensed rapidly.

The signal transmission apparatus according to each embodiment is not limited to a forward base station installed in each micro-cell of a micro-cell transmission system. The signal transmission apparatus can be applied in the same manner to between a forward base station including an antenna extension station or the like installed in a radio dead zone such as a tall building, an underground shopping area, etc., and a wireless base station. The level of an up reception signal input to the wireless base station and the transmission power level of the forward base station can be kept in predetermined levels with a simple configuration.

Although the present invention has been described in detail and with reference to its specific embodiments, it is obvious for those skilled in the art that various changes or modifications can be made on the invention without departing from its spirit and scope.

This application is based on a Japanese patent application (patent application number 2004-202911) filed on Jul. 9, 2004, whose contents are incorporated herein by reference.

### INDUSTRIAL APPLICABILITY

The present invention has an effect that up and down signal levels in a wireless base station and a forward base station can be automatically adjusted to predetermined levels with a simple configuration. It is useful to a signal transmission apparatus or the like in a mobile communication system of a micro-cell transmission system or the like.

1. A signal transmission apparatus for bidirectionally transmitting signals between a wireless base station and a forward base station in a mobile communication system, the forward base station being connected to the wireless base station through a wire transmission line and conducting wireless communication with a communication terminal, the signal transmission apparatus comprising:
an interface portion that is provided in an input/output portion of the wireless base station,
wherein the interface portion includes:
a pilot signal generation portion which generates a pilot signal; and
a multiplexer which multiplexes the pilot signal with a down transmission signal to be transmitted to the forward base station,
wherein the interface portion transmits the down transmission signal output from the multiplexer to the forward base station through the wire transmission line; and
wherein the forward base station includes:
a demultiplexer which demultiplexes the pilot signal from the down transmission signal transmitted from the wireless base station;
a down signal gain variable amplification portion which amplifies the down transmission signal;
an up signal gain variable amplification portion which amplifies an up reception signal received from the communication terminal; and
a gain control portion which generates a gain control signal in accordance with a level of the pilot signal and supplies the gain control signal to the down signal gain variable amplification portion and the up signal gain variable amplification portion so as to control output levels of the down transmission signal and the up reception signal.

2. The signal transmission apparatus according to claim 1, wherein the wire transmission line is constituted by an optical fiber cable so as to transmit a down optical signal and an up optical signal between the interface portion and the forward base station;
wherein the interface portion further includes:
a first electro-optic converter which converts the down transmission signal into the down optical signal; and
a first opto-electric converter which converts the up optical signal transmitted from the forward base station, into the up reception signal; and
wherein the forward base station further includes:
a second opto-electric converter which converts the down optical signal transmitted from the interface portion, into the down transmission signal; and
a second electro-optic converter which converts the up reception signal amplified by the up signal gain variable amplifier, into the up optical signal.

3. The signal transmission apparatus according to claim 2, wherein the wire transmission line is constituted by a single optical fiber;
wherein the interface portion further includes:
a first optical multi/demultiplexer which is connected to the optical fiber and performs wavelength division multiplexing transmission of the down optical signal and the up optical signal with the forward base station; and
wherein the forward base station further includes:
a second optical multi/demultiplexer which is connected to the optical fiber and performs wavelength division multiplexing transmission of the up optical signal and the down optical signal with the interface portion.

4. A signal transmission apparatus for bidirectionally transmitting signals between a wireless base station and a forward base station in a mobile communication system, the forward base station being connected to the wireless base station through a wire transmission line and conducting wireless communication with a communication terminal, the signal transmission apparatus comprising:
an interface portion that is provided in an input/output portion of the wireless base station, and the wire transmission line is made of a metallic cable,
wherein the interface portion includes:
a DC power generation portion which generates DC power; and
a superposition circuit which superposes the DC power on a down transmission signal to be transmitted to the forward base station;
wherein the interface portion transmits the down transmission signal output from the superposition circuit to the forward base station through the wire transmission line; and
wherein the forward base station includes:
a separation circuit which separates the DC power from the down transmission signal transmitted from the wireless base station;
a down signal gain variable amplification portion which amplifies the down transmission signal;
an up signal gain variable amplification portion which amplifies an up reception signal received from the communication terminal; and
a gain control portion which generates a gain control signal in accordance with a value of the DC power and supplies the gain control signal to the down signal gain variable amplification portion and the up signal gain variable amplification portion so as to control output levels of the down transmission signal and the up reception signal.

5. A signal transmission apparatus for bidirectionally transmitting signals between a wireless base station and a forward base station in a mobile communication system, the forward base station being connected to the wireless base station through a wire transmission line and conducting wireless communication with a communication terminal, the signal transmission apparatus comprising:
an interface portion that is provided in an input/output portion of the wireless base station, and the wire transmission line is made of a metallic cable including a down transmission line for transmitting a down transmission signal from the wireless base station to the forward base station and an up transmission line for transmitting an up reception signal from the forward base station to the wireless base station,
wherein the interface portion includes:
a pilot signal generation portion which generates a pilot signal; and
a multiplexer which multiplexes the pilot signal on the up transmission line; and
wherein the forward base station includes:
a demultiplexer which demultiplexes the pilot signal input through the up transmission line;
a down signal gain variable amplification portion which amplifies the down transmission signal;
an up signal gain variable amplification portion which amplifies an up reception signal received from the communication terminal; and
a gain control portion which generates a gain control signal in accordance with a level of the pilot signal and supplies the gain control signal to the down signal gain variable amplification portion and the up signal gain variable amplification portion so as to control output levels of the down transmission signal and the up reception signal.

6. The signal transmission apparatus according to claim 2, wherein the interface portion further includes:
a first current detection portion which detects a value of a current flowing in the first opto-electric converter; and
a first alarm output portion which compares the detected current value with a predetermined value, and outputs an alarm signal when the detected current value is lower than the predetermined value; and
wherein the forward base station further includes:
a second current detection portion which detects a value of a current flowing in the second opto-electric converter; and
a second alarm output portion which compares the detected current value with a predetermined value, and outputs an alarm signal when the detected current value is lower than the predetermined value.

7. The signal transmission apparatus according to claim 5, wherein the forward base station further includes:
a first pilot signal detection portion which detects the demultiplexed pilot signal;
a first alarm output portion which compares a level of the detected pilot signal with a predetermined value, and outputs an alarm signal when the level of the detected pilot signal is lower than the predetermined value; and
a second multiplexer which multiplexes the demultiplexed pilot signal on the down transmission line; and
wherein the interface portion further includes:
a second demultiplexer which demultiplexes the pilot signal input through the down transmission line;
a second pilot signal detection portion which detects the demultiplexed pilot signal; and
a second alarm output portion which compares a level of the detected pilot signal with a predetermined value, and outputs an alarm signal when the level of the detected pilot signal is lower than the predetermined value.
